(19) United States
(12) Patent Application Publication
(10) Pub. No.: US 2026/0073426 A1
(43) Pub. Date: Mar. 12, 2026

(54) CAMERA-INTEGRATED WIRELESS 3D MAPPING AND TRACKING SYSTEM

(71) Applicant: Infinitus Holdings Inc., Penn Valley, PA (US)

(72) Inventors: Joshua Ian Cohen, Penn Valley, PA (US); John Cronin, Jericho, VT (US)

(21) Appl. No.: 18/826,846

(22) Filed: Sep. 6, 2024

(51) Int. Cl. G06Q 30/0251; G01S 13/42; G01S 13/72; G01S 13/86; G06Q 50/00; G06T 7/70; G06V 10/40; G06V 10/764; G06V 20/20

(52) U.S. Cl. CPC G06Q 30/0267; G01S 13/42; G01S 13/72; G01S 13/867; G06Q 10/40; G06T 7/70; G06V 10/40; G06V 10/764; G06V 20/20; G06T 2207/30244

(57) ABSTRACT

A system includes a phased array antenna, a signal processing module configured to detect wireless signals received from one or more target devices, a conversion module configured to determine 3D spatial data for the one or more target devices based on the wireless signals, an integration module configured to receive visual data from at least one camera, perform object detection and classification on the visual data to detect and classify one or more objects, and tag the one or more objects with 3D coordinates based on the 3D spatial data for the one or more target devices; and a correlation module configured to synchronize the 3D spatial data from the conversion module with the visual data from the integration module including object detection and classification information for use in a cloud-based augmented reality (AR) content to augment social networking and targeted advertising.

### FIELD OF THE DISCLOSURE

The present disclosure is generally related to device tracking and more specifically to a camera-integrated wireless 3D mapping and tracking system.

### BACKGROUND

Traditional tracking systems in augmented reality environments often suffer from inaccuracies, especially in determining the precise location and orientation of mobile devices. This lack of precision can hinder interactive experiences and reduce the effectiveness of applications that rely on accurate spatial data. In addition, augmented reality applications often struggle to provide seamless interaction between users and virtual objects due to the inability to accurately capture and respond to user gestures and movements. Many businesses struggle to deliver targeted advertisements and personalized content in real-world environments, particularly in retail settings, due to a lack of precise user location data. Furthermore, ensuring security in restricted areas is challenging, particularly in tracking and identifying individuals accurately, which is used for preventing unauthorized access and ensuring safety. Thus, there is a need in the prior art to provide a camera-integrated wireless 3D mapping and tracking system.

### SUMMARY

According to one aspect, a system includes a phased array antenna and a signal processing module configured to detect wireless signals received from one or more target devices. The system also includes a conversion module configured to determine 3D spatial data for the one or more target devices based on the wireless signals. The system further includes an integration module configured to receive visual data from at least one camera, perform object detection and classification on the visual data to detect and classify one or more objects, and tag the one or more objects with 3D coordinates based on the 3D spatial data for the one or more target devices. In addition, the system includes a correlation module configured to synchronize the 3D spatial data from the conversion module with the visual data from the integration module including object detection and classification information for use in a cloud-based augmented reality (AR) content to augment social networking and targeted advertising.

In some embodiments, the system further includes a modular camera system including the at least one camera, wherein the modular camera system further includes a wireless transmitter configured to transmit the visual data from the at least one camera to the integration module.

In some embodiments, the signal processing module operates in an active mode by initially pinging the one or more target devices via the phased array antenna before detecting the wireless signals from the one or more target devices. In other embodiments, the signal processing module operates in a passive mode by detecting the wireless signals without first pinging the one or more target devices.

In some embodiments, the conversion module determines the 3D spatial data for the one or more target devices by triangulation and/or trilateration.

In some embodiments, the conversion module determine the 3D spatial data for the one or more target devices using at least one of an Angle of Arrival (AoA) measurement, a Time of Arrival (ToA) measurement, a Kalman filter, a Joint Probabilistic Data Association (JPDA) operation, and/or a Multiple Signal Classification (MUSIC) algorithm.

In some embodiments, the integration module is further configured to perform object recognition on the one or more objects using machine learning.

In some embodiments, the integration module is further configured to perform pose estimation to determine an orientation and position of the one or more objects in 3D space.

In some embodiments, the integration module performs the pose estimation using one or more of Perspective-n-Point (“PnP”) algorithms and triangulation.

In some embodiments, the integration module is further configured to perform feature extraction on the one or more objects to extract one or more features, generate a descriptor for the one or more objects based on the one or more features; and associate the descriptor with the one or more objects as a tag.

In some embodiments, the integration module is configured to use object classification to assign the one or more objects to a particular category.

According to another aspect, a method includes detecting, by a phased array antenna, wireless signals received from one or more target devices and determining 3D spatial data for the one or more target devices based on the wireless signals. The method also includes receiving visual data from at least one camera and performing object detection and classification on the visual data to detect and classify one or more objects. The method further includes tagging the one or more objects with 3D coordinates based on the 3D spatial data for the one or more target devices. In addition, the method includes synchronizing the 3D spatial data with the visual data and object detection and classification information for use in a cloud-based AR content to augment social networking and targeted advertising.

In some embodiments, the at least one camera is part of a modular camera system including a wireless transmitter.

In some embodiments, detecting is performed in an active mode by initially pinging the one or more target devices via the phased array antenna before detecting the wireless signals from the one or more target devices; or wherein detecting is performed in a passive mode by detecting the wireless signals without first pinging the one or more target devices.

In some embodiments, determining the 3D spatial data for the one or more target devices includes using one or more of triangulation and/or trilateration.

In some embodiments, determining the 3D spatial data for the one or more target devices includes using one or more of an Angle of Arrival (AoA) measurement, a Time of Arrival (ToA) measurement, a Kalman filter, a Joint Probabilistic Data Association (JPDA) operation, and/or a Multiple Signal Classification (MUSIC) algorithm.

In some embodiments, the method further includes performing object recognition on the one or more objects using machine learning.

In some embodiments, the method further includes performing pose estimation to determine an orientation and position of the one or more objects in 3D space.

In some embodiments, performing the pose estimation includes using one or more of Perspective-n-Point (“PnP”) algorithms and triangulation.

In some embodiments, the method further includes performing feature extraction on the one or more objects to extract one or more features, generating a descriptor for the one or more objects based on the one or more features, and associating the descriptor with the one or more objects as a tag.

In some embodiments, the method further includes including performing object classification to assign the one or more objects to a particular category.

### BRIEF DESCRIPTION OF THE DRAWINGS

FIG. 1 is a schematic diagram of a camera-integrated wireless 3D mapping and tracking System according to an embodiment.

FIG. 2 is a flowchart of a method performed by a Signal Processing Module according to an embodiment.

FIG. 3 is a flowchart of a method performed by a Conversion Module, according to an embodiment.

FIG. 4 is a flowchart of a method performed by an Integration Module according to an embodiment.

FIG. 5 is a flowchart of a method performed by a Correlation Module according to an embodiment.

FIG. 6 is a flowchart of a method performed by a Sync Module according to an embodiment.

FIG. 7 is a flowchart of a method performed by a Processing Module according to an embodiment.

FIG. 8 is a flowchart of a method performed by an Application Module according to an embodiment.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

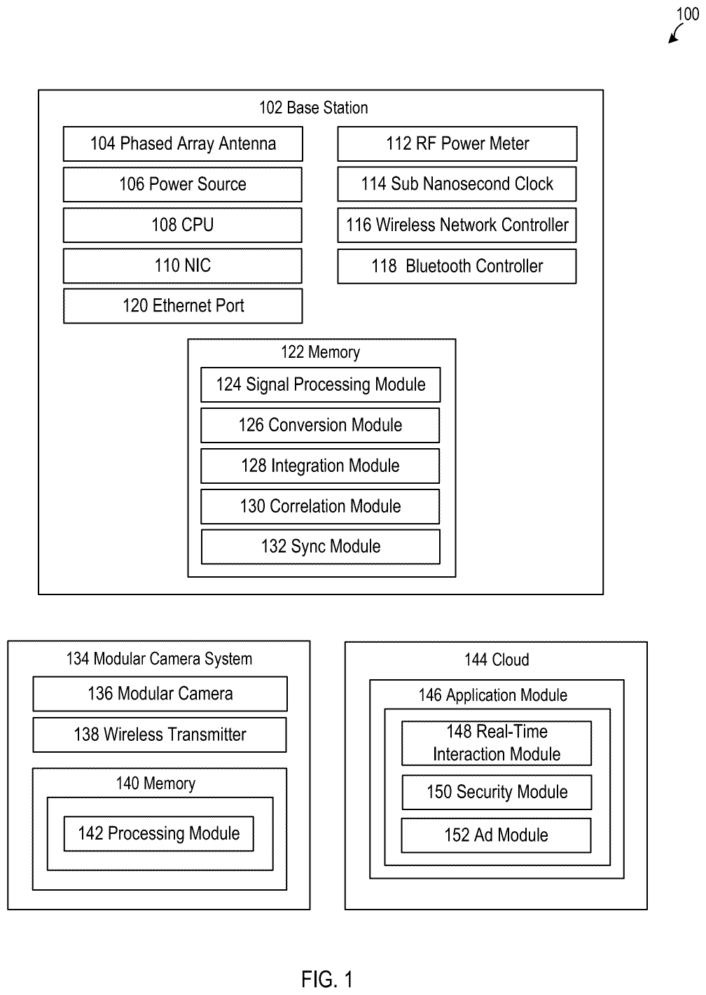

FIG. 1 illustrates a camera-integrated wireless 3D mapping and tracking system 100 (or “system 100”). The system 100 includes a base station 102, which may serve as the hub for data collection, processing, and communication and provides tracking, real-time data processing, and connectivity. The base station 102 may receive signals, process data, and ensure accurate tracking and synchronization across various components and applications. The base station 102 may include a phased array antenna 104, power source 106, CPU 108, NIC 110, RF power meter 112, sub nanosecond clock 114, wireless network controller 116, Bluetooth controller 118, ethernet port 120, and memory 122 for storing various modules, such as, without limitation, a signal processing module 124, conversion module 126, integration module 128, correlation module 130, and a sync module 132.

The phased array antenna 104 captures signals from multiple devices, and the signal processing module 124 employs algorithms to extract tracking information from the signals. The conversion module 126 may transform the raw signal data into 3D coordinates, making it easier to correlate with other data streams. The integration module 128 may then perform image processing tasks, such as object detection and feature extraction, to identify objects, estimate their pose, and tag them with 3D coordinates, ensuring that all positional data is consistent across different sensors. The correlation module 130 merges the data from various sources by aligning the signal data with any visual data collected by the modular camera system 134. This ensures that all data streams are synchronized and accurately represent the environment. The integrated data may be used to generate comprehensive situational awareness, which can be leveraged for applications like real-time tracking, security monitoring, or AR experiences.

The sync module 132 may handle the communication aspect, ensuring that all processed data is accurately transmitted to cloud 144 servers or other application modules, including managing the timing and format of data uploads to ensure minimal latency and high data integrity. In some embodiments, the base stations 102 may be used in a distributed network topology, in which the base stations 102 collaborate to share computational tasks, enhancing the system's overall processing capability and efficiency.

In some embodiments, each base station 102 may be equipped with its own processing unit, such as a CPU 108 or GPU, and may handle a portion of the computational load. In some embodiments, in a distributed processing topology the computational tasks may be distributed among multiple base stations 102 based on their processing capacity and current load. The distribution balances the load and prevents any single base station 102 from becoming a bottleneck. In some embodiments, multiple base stations 102 may work on different parts of a task simultaneously, reducing processing time. For example, in an AR application, one base station 102 may handle image processing, another may process location data, and a third may render the AR content. In some embodiments, the system may continue functioning even if one or more base stations 102 fail, as the tasks may be redistributed to other functioning base stations 102. In some embodiments, the base stations 102 may also participate in a distributed data storage system, where data is stored across multiple nodes. In some embodiments, data may be replicated across multiple base stations 102 to ensure that there is no single point of failure. If one base station 102 goes offline, the data is still accessible from other nodes. In some embodiments, the storage capacity may be scaled by adding more base stations 102 to the network, which may be used to handle large volumes of data, such as high-resolution video feeds or extensive sensor data. In some embodiments, data may be stored closer to the point of use, reducing latency in data retrieval and improving performance. For example, data relevant to a specific area may be stored on base stations 102 located in that area, ensuring faster access. In some embodiments, base stations 102 may route signals among themselves in a distributed mesh network topology, forming a decentralized communication network. In some embodiments, signals may take multiple paths through the network, allowing for dynamic routing based on current network conditions, such as congestion or node failures. In some embodiments, the mesh topology may be inherently resilient, as it does not rely on a single communication path. If a path becomes unavailable, the system may reroute signals through alternative paths, maintaining communication integrity. In some embodiments, the mesh network may cover a wide area by using multiple base stations 102 to relay signals. In some embodiments, the extended coverage may be useful in large facilities, remote areas, or environments with obstacles that might hinder direct communication. In some embodiments, other devices such as mobile phones, laptops, asset tags, and other capable device may also participate in the distributed network. In some embodiments, the devices may include an appropriate application to contribute and benefit from the distributed network. In some embodiments, users who opt in through applications on their devices may share processing power, data storage, or network connectivity. In some embodiments, the devices may act as additional nodes in the distributed network, enhancing its capabilities and reach. In some embodiments, the asset tags may provide real-time location data, environmental readings, or other sensor information, and may connect to the nearest base station 102 or other devices in the mesh network, ensuring continuous data flow and monitoring. In some embodiments, devices such as smartwatches, wearable sensors, or IoT devices may join the network, contributing data or acting as nodes for data relay.

Further, embodiments may include a phased array antenna 104, which includes an array of elements that may function in both passive and active modes. In the passive mode, the phased array antenna 104 does not transmit any signals but listens to all wireless traffic within its vicinity, capturing signals without interacting with the devices being monitored. In some embodiments, the passive approach allows for discreet monitoring and reduces the likelihood of detection by the tracked devices. In the active mode, the phased array antenna 104 may transmit signals and then receive the reflected signals back, enabling more dynamic interaction with the environment. In some embodiments, the phased array antenna 104 array may be capable of operating across diverse frequency ranges to support various applications, from consumer wireless communication to military radar systems. In some embodiments, the phased array antenna 104 may be designed to operate at 2.4 GHz and/or 5 GHz for Wi-Fi or Bluetooth applications, with each antenna element being 2.1 inches in size, forming a 16-channel array that measures approximately 20 inches by 20 inches. In some embodiments, the phased array antenna 104 array may be designed to operate at X-band, such as 8-12 GHz, S-band, such as 2-4 GHz, C-band, such as 4-8 GHz, or L-band, such as 1-2 GHz, which are used in various applications such as missile guidance, air traffic control, surface ship radar, satellite communications, and long-range radar systems, offering a range of capabilities including good resolution, range, and weather penetration. In some embodiments, the phased array antenna 104 array may be designed to operate at various cellular frequencies, such as 700-800 MHz for long-distance LTE communication with good building penetration, 1.7-2.1 GHz for LTE and 3G/4G services balancing coverage and data speeds, or 2.3-2.7 GHz for higher data rates in LTE-A and 5G over shorter distances, which provides varying benefits in terms of range and data throughput. In some embodiments, the configuration may allow the phased array antenna 104 to cover a wide area and detect signals from multiple devices simultaneously. In some embodiments, the configuration allows the phased array antenna 104 to cover a wide area and detect signals from multiple devices simultaneously. The array's design supports both angle of arrival (“AoA”) measurements and Doppler shift calculations, which may be used to determine the direction and movement of the tracked devices. The phased array antenna 104 may also include null space reduction, which helps identify and minimize the effects of nulls or dead zones in the signal reception pattern. The null space reduction may analyze the signals received from different antennas in the array and adjust the reception parameters to improve signal clarity and reduce interference. In some embodiments, the phased array antenna 104 may support signal processing capabilities. The phased array antenna 104 may work in conjunction with tools, such as a Kalman filter for prediction and smoothing of device positions, Joint Probabilistic Data Association (“JPDA”) algorithm for accurate data association in environments with multiple devices, and an outlier module to eliminate false signals and improve overall tracking accuracy. These features collectively enable the system to provide precise and reliable tracking and interaction with wireless devices in its vicinity.

Further, embodiments may include a power source 106, which may be an AC power supply, providing a stable and continuous source of electricity. In some embodiments, the AC power supply ensures that the base station 102 operates without interruption, supporting the continuous monitoring and reporting of wireless device activities within the coverage area. In some embodiments, the base station 102 may rely on DC power sources, such as batteries or rechargeable battery packs. These portable power sources 106 enable the base station 102 to be used in dynamic or remote environments where access to AC power is limited or unavailable. In some embodiments, rechargeable batteries may provide the flexibility of being recharged and reused, making them suitable for operations that use mobility or temporary setups, such as event monitoring, security patrols, or search and rescue missions.

Further, embodiments may include a CPU 108 or central processing unit, which may be the component responsible for executing instructions and managing the operations of the system. The CPU 108 may be a highly integrated electronic circuit that performs arithmetic, logic, control, and input/output operations specified by the instructions in the program. In some embodiments, the CPU 108 in the base station 102 may be designed to handle the demanding processing requirements associated with the various technologies integrated into the system. In some embodiments, the CPU 108 may be a multi-core processor featuring multiple processing units or cores on a single chip. Each core is capable of executing its instructions independently of the others, allowing for parallel processing. In some embodiments, the base station 102 may include GPU, or graphic processing unit, which may be designed to accelerate the processing of graphics and computational tasks. In some embodiments, the GPU may be optimized for parallel processing and may handle multiple tasks simultaneously to process large amounts of data, such as images, videos, and algorithms used in machine learning and artificial intelligence. In some embodiments, the GPU may be used for real-time image and video processing, deep learning inference, signal processing, and other data-intensive operations, and may improve the system's performance, enabling more sophisticated applications like augmented reality, real-time analytics, and enhanced security features. In some embodiments, the base station 102 may include multiple CPUs 108. In some embodiments, the base station 102 may include multiple GPUs. In some embodiments, the base station 102 may include multiple GPUs and one CPU 108. In some embodiments, the base station 102 may include multiple CPUs 108 and a one GPU. In some embodiments, the base station 102 may include multiple CPUs 108 and multiple GPUs.

Further, embodiments may include a network interface card 110 (or “NIC 110”), which may be a hardware component that enables the base station 102 to connect to a network. The NIC 110 may be designed to handle the functions for establishing and maintaining network communication. In some embodiments, the NIC 110 may include several components, such as the network interface controller, transceivers, and connectors, housed on a single board. The NIC 110 may operate by interfacing with the base station's 102 operating system and network software to manage data transmission and reception over a network. In some embodiments, the NIC 110 may provide a physical interface for the network cable, such as Ethernet, Wi-Fi, or other types of network connections. In some embodiments, the NIC 110 may contain transceivers that convert electrical signals to and from network cables into data the base station 102 can process. In some embodiments, the NIC 110 may include connectors and other circuitry to manage the electrical signals and ensure efficient and accurate data transmission. The NIC 110 may prepare data for transmission over the network and to process incoming data. The NIC 110 may encapsulate data packets according to the network protocols being used, manage error detection and correction, and control the flow of data to prevent congestion. The NIC 110 may handle the conversion of data from parallel to serial form for transmission over the network medium and from serial to parallel form upon receipt. In some embodiments, the NIC 110 may include firmware or software that interfaces with the base station's 102 operating system. The software component may be responsible for handling the low-level operations of network communication, such as packet generation, data buffering, and signal encoding/decoding. The NIC 110 firmware may ensure that the hardware functions are abstracted in a way that the operating system can manage network communication seamlessly, allowing for network drivers to facilitate communication between the base station 102 and the network.

In some embodiments, the NIC 110 may include a network interface controller, which may be a chip or a set of integrated circuits that handles the processing of network data and communication tasks. The network interface controller may be responsible for the actual management of data transfer between the computer's internal bus system and the network media. In some embodiments, the network interface controller may manage the sending and receiving of data packets, ensuring that data is transmitted correctly and efficiently across the network. When data is sent from the base station 102, the controller takes parallel data from the base station's 102 bus and converts it into serial data to be sent over the network cable. Conversely, when data is received, the controller converts serial data from the network back into parallel data for the base station 102 to process. In some embodiments, the controller may handle error detection and correction by using various algorithms to check the integrity of the data packets being transmitted and received to ensure that errors are detected and corrected before the data reaches its destination. In some embodiments, the controller may manage the data buffering process by temporarily storing data in buffers to smooth out the differences in data transmission rates between the base station 102 and the network to help manage network congestion and ensure that data flows smoothly without overwhelming either the sending or receiving ends. In some embodiments, the controller may manage network protocols by handling the low-level operations used by different network protocols, such as Ethernet or Wi-Fi, including addressing, packet framing, and collision detection and avoidance, allowing the NIC 110 to communicate effectively over various types of networks and ensures compatibility with different networking standards.

Further, embodiments may include an RF power meter 112, a precision instrument that measures and monitors the power levels of radio frequency signals transmitted and received by the phased array antenna 104. The RF power meter 112, with its high-precision sensor capable of detecting RF power across a wide range of frequencies, an analog-to-digital converter (“ADC”), for accurate signal processing, and a microcontroller unit (“MCU”) to manage data collection and analysis, instills confidence in its accuracy. The sensor continuously measures the RF power of signals, converting these measurements into electrical signals that the ADC digitizes. The digitized data is then processed by the MCU, which interprets the power levels and provides real-time feedback to the system. In some embodiments, the RF power meter 112 ensures that the phased array antenna 104 operates within optimal power levels, avoiding underpowered or overpowered conditions that could degrade performance. The RF power meter 112 may dynamically adjust the transmission power to maintain consistent signal strength and quality, compensating for environmental changes or variations in signal propagation to maintain efficient communication links and prevent signal loss or distortion.

Further, embodiments may include a sub-nanosecond clock 114, a reliable timing device designed to provide highly accurate and precise synchronization for the operations of the phased array antenna 104. The sub-nanosecond clock 114 may generate timing signals with a resolution of less than one nanosecond for applications requiring ultra-high precision in signal processing and communication. In some embodiments, the sub-nanosecond clock 114 includes an oscillator, such as a crystal oscillator or an atomic clock, that ensures minimal drift and high accuracy over time. The oscillator may be connected to a phase-locked loop (“PLL”), a circuit that multiplies the base frequency to achieve the desired sub-nanosecond resolution. In some embodiments, the PLL may ensure that the timing signals remain stable and synchronized with the system's operations. The sub-nanosecond clock 114 plays a useful role in ensuring that the transmission and reception of signals are accurately synchronized to maintain the integrity of the communication link and avoid timing errors that could lead to data corruption or loss. In some embodiments, the sub-nanosecond clock 114 provides precise timestamps for the received signals to allow the base station 102 to accurately calculate the time differences between signals arriving at different elements of the phased array to determine the exact direction of the incoming signals. In some embodiments, the sub-nanosecond clock 114 may enable the base station 102 to measure minute changes in the frequency of the received signals due to the Doppler effect, allowing for accurate tracking of the speed and direction of the devices. In some embodiments, the sub-nanosecond clock 114 may provide the timing reference for the digital signal processor (“DSP”) and other processing units within the base station 102 to ensure that all data processing tasks are performed in a synchronized manner.

Further, embodiments may include a wireless network controller 116, which may be responsible for managing wireless communications between the base station 102 and the wireless devices within their vicinity. In some embodiments, the wireless network controller 116 may oversee the operations of the NIC 110, including signal monitoring, data capture, and communication with other system components. The wireless network controller 116 may operate by placing the NIC 110 into a specific mode, such as monitor mode, which allows the NIC 110 to passively listen to all wireless traffic within its range without initiating any connections or interactions with the devices being monitored. The wireless network controller 116 may capture various wireless frames, particularly management frames such as probe requests. These frames contain specific information, including MAC addresses, SSIDs, signal strengths, and supported rates of the wireless devices. By capturing and processing these frames, the wireless network controller helps build a comprehensive profile of each detected device. In some embodiments, the wireless network controller 116 may periodically scan different frequency channels. This scanning process allows the NIC 110 to detect devices operating on various channels, minimizing the chances of missing any signals. Additionally, the wireless network controller 116 may engage in channel hopping, in which the NIC 110 frequently switches between channels at specified intervals, further enhancing the detection capability by broadening the range of monitored frequencies. The wireless network controller 116 may perform data extraction to isolate relevant information from the frames, which may involve focusing on specific details, such as MAC addresses, network names (SSIDs), and signal strengths. The extracted data is then preprocessed to filter out irrelevant or redundant information, ensuring that valuable and pertinent data is retained. The refined data may be structured in a format that facilitates efficient transmission to the system's servers for further processing and analysis. In some embodiments, the wireless network controller 116 may ensure that the data is serialized and encrypted, maintaining the integrity and security of the information during transmission.

Further, embodiments may include a Bluetooth controller 118, which may be responsible for managing Bluetooth communications between the base station 102 and Bluetooth-enabled devices. The Bluetooth controller 118 may control the Bluetooth chipset, enabling the detection, tracking, and processing of Bluetooth signals within the base station's 102 vicinity. In some embodiments, the Bluetooth controller 118 may operate by placing the Bluetooth chipset into a passive monitoring mode. In this mode, the chipset listens to Bluetooth signals within its range without actively connecting or interacting with the devices being monitored. The Bluetooth controller 118 may capture various Bluetooth packets, including device names, Bluetooth addresses, signal strengths, supported services, and other metadata. By capturing and processing these packets, the Bluetooth controller 118 builds a comprehensive profile of each detected Bluetooth-enabled device. In some embodiments, the Bluetooth controller 118 may perform data extraction to isolate relevant information from the packets, which may involve focusing on specific details, such as Bluetooth addresses, device names, and signal strengths, which form the basis for further analysis and processing. The extracted data is then preprocessed to filter out irrelevant or redundant information, ensuring that valuable and pertinent data is retained. The refined data is structured in a format that facilitates efficient transmission to the system's servers for further processing and analysis. The Bluetooth controller 118 ensures that the data is serialized and encrypted, maintaining the integrity and security of the information during transmission.

Further, embodiments may include an ethernet port 120, which may be a hardware interface that enables wired network connectivity for the base station 102 and other system components. The ethernet port 120 may facilitate the transmission and reception of data between the base station 102 and the system's servers or other networked devices over a wired Ethernet connection. In some embodiments, the ethernet port 120 may enable the base station 102 to transmit captured and processed data to the system's servers for further analysis and storage. This data may include wireless signal information, device metadata, and other relevant tracking and authentication details.

Further, embodiments may include a memory 122, which may be implemented as flash memory, which contains code logic for various functions, including monitoring, reporting, and other processing tasks. The memory 122 may contain software such as the signal processing module 124, conversion module 126, integration module 128, correlation module 130, and sync module 132. The memory 122 may be responsible for temporarily storing the captured wireless signals and their metadata, ensuring that the data is readily accessible for preprocessing and transmission to the system's servers. In some embodiments, the memory 122 may store configuration settings, firmware updates, and other files that enable the base station 102 to function efficiently and effectively.

Further, embodiments may include a signal processing module 124, which handles and refines the signals received from target devices. The signal processing module 124 may utilize the Angle of Arrival (“AoA”) module to pinpoint the direction of the incoming signal. The AoA module calculates the angle by analyzing time and phase differences captured by these elements, utilizing beamforming to enhance accuracy. The Kalman module is engaged to predict and smooth the position of the tracked devices by filtering the incoming data, which may involve initializing a state vector that includes the device's position and velocity, which is continuously updated as new measurements are taken. The track module then assigns incoming signals to the correct devices by using algorithms, such as the Joint Probabilistic Data Association (“JPDA”) algorithm, to handle specific signal environments, ensuring signals are matched to the correct devices. The signal processing module 124 may employ the JPDA algorithm to improve data association accuracy, especially in dense signal environments. The JPDA algorithm calculates the likelihood of various signal-to-device associations, optimizing these associations for reliability. The outlier module addresses out-of-sequence data, ensuring the tracking system maintains accuracy even with delayed or disordered data packets. The refined and structured data is then forwarded to the conversion module 126 for further processing into usable 3D coordinates.

Further, embodiments may include a conversion module 126, which may transform raw signal data into precise three-dimensional or 3D spatial coordinates. The conversion module 126 continuously polls and receives data from the signal processing module 124, including information such as the angle of arrival, (“AoA”) and time of arrival (“ToA”) of signals. The conversion module 126 may use these inputs to calculate accurate 3D positions through techniques like triangulation and coordinate transformation. The conversion module 126 may employ calibration and error correction methods to ensure the accuracy of the data. The output, including the 3D coordinates and error estimates, is stored and made available for further processing and integration with other system components.

Further, embodiments may include an integration module 128, which establishes a connection with the processing module 142 to receive pre-processed image data. The data undergoes object detection, in which machine learning algorithms identify and locate objects within the scene. The integration module 128 extracts unique features from these objects, such as edges and textures, to create descriptors. The features are used in object recognition and classification, matching the objects to a database to identify their type and category. The integration module 128 performs pose estimation to determine each object's orientation and position in 3D space. The objects are then tagged with precise 3D coordinates, providing accurate real-world positioning. Then, the processed data, including object detections, features, classifications, poses, and 3D location tags, is sent to the correlation module 130.

Further, embodiments may include a correlation module 130, which integrates and synchronizes data from the conversion module 126 and integration module 128. The correlation module 130 receives 3D spatial data from the conversion module 126, which has been derived from signal processing. The correlation module 130 receives detailed visual data from the integration module 128, which includes object detection and classification information. The correlation module 130 then synchronizes these datasets, aligning the timing and spatial coordinates to ensure accurate matching of visual and spatial information. The correlation module 130 integrates tags from both data sources, providing a unified view of each tracked object or entity. The data is sent to the sync module 132 for further processing or use in real-time applications.

Further, embodiments may include a sync module 132, which may be responsible for transmitting synchronized data from the correlation module 130 to the application module 146 in real time. The sync module 132 may begin by receiving the processed data, which includes precise 3D positional and visual information, from the correlation module 130. The sync module 132 may then establish a secure and reliable connection with the application module 146, ensuring that the communication channel can handle the data's volume and speed requirements. The sync module 132 may transmit the data to the application module 146, ensuring minimal latency and maintaining data integrity.

Further, embodiments may include a modular camera system 134, which captures visual information and performs basic image pre-processing before transmitting the data to the base station 102 for analysis and integration. In some embodiments, the modular camera system 134 may include a modular camera 136, which may have a plurality of lens options and mounting options and be adjustable. In some embodiments, the modular camera 136 may be equipped with lenses, such as fish-eye, wide-angle, or movable lenses, allowing the system to adapt to various environmental needs, such as wide-area coverage or focused observation. In some embodiments, the modular camera 136 may be mounted on ceilings, poles, or other structures to maximize the field of view, minimize obstructions, and cover large areas effectively. In some embodiments, the modular camera 136 may include mechanisms for adjusting the lens or camera position, allowing dynamic tracking of moving objects or areas of interest. In some embodiments, the modular camera system 134 may include a wireless transmitter 138 to send captured visual data to the base station 102, providing for flexible placement of cameras 136 without extensive wiring. In some embodiments, the modular camera system 134 may include a memory 140 which may contain a processing module 142 that captures and pre-processes the visual data before transmitting the data to the base station 102. In some embodiments, the modular camera system 134 may provide additional functions, such as computer vision in robotics, facial recognition, theft detection, fire detection, detect dangerous situations, etc. For example, the modular camera system 134 may be used for robotics, acting as the “eyes” of robotic systems. The camera 136 may provide data for navigation, object recognition, and manipulation. In industrial settings, cameras 136 may be used to guide robotic arms with precision, ensuring accurate handling and assembly of components. For mobile robots, the cameras 136 may provide visual feedback that helps in obstacle detection and avoidance, allowing the robots to navigate environments safely. In some embodiments, computer vision techniques, such as deep learning, may enable robots to identify and categorize objects, recognize human gestures, and adapt their actions accordingly. In some embodiments, multiple cameras 136 may be used to provide stereoscopic vision, giving robots depth perception to better understand the 3D structure of their surroundings. For example, for airport security, cameras 136 may be equipped with facial recognition technology to enhance the efficiency and accuracy of identity verification processes. In some embodiments, as passengers move through different checkpoints, such as check-in, security screening, and boarding gates, cameras 136 may capture facial images and compare them with stored biometric data. In some embodiments, this may streamline the passenger identification process, reducing wait times and enhancing security, and assist in identifying persons of interest or those on watchlists, allowing security personnel to respond swiftly. In some embodiments, the use of facial recognition may also be extended to access control in restricted areas, ensuring authorized individuals gain entry. In some embodiments, in retail environments, cameras 136 may be integrated with AI and machine learning (“ML”) algorithms that may detect theft and other suspicious activities in real-time. In some embodiments, the system may analyze video feeds to identify behaviors indicative of shoplifting, such as hiding items, frequent visits to specific areas without purchases, or unusual movements. Upon detecting such behaviors, the system may alert store personnel or security teams to intervene. In some embodiments, the system may track inventory levels and monitor customer behavior to optimize store layouts and product placements. In some embodiments, the modular camera system 134 may utilize thermal imaging cameras 136 that may sense temperature anomalies that indicate the presence of a fire or overheating equipment, enabling early detection and prompt response to prevent damage and ensure safety. In some embodiments, for spill detection, such as in industrial settings, cameras 136 may monitor areas for liquid spills or leaks, alerting personnel to potential hazards to prevent accidents, especially in environments dealing with hazardous materials. In some embodiments, the modular camera system 134 may utilize computer vision systems that may analyze video feeds to identify potentially dangerous situations, such as fights, crowding, or unauthorized access. For example, in public spaces like stadiums or shopping malls, cameras 136 may detect sudden movements or aggressive behaviors that may indicate a fight. The system may then notify security personnel, allowing for quick intervention. In some embodiments, the cameras 136 may monitor areas for unusual activities, such as loitering or trespassing, which may indicate security threats.

Further, embodiments may include a modular camera 136, which may capture high-resolution visual data and may be configured with different lenses and mounting options to suit various environmental and operational needs. In some embodiments, the modular camera 136 may use a fish-eye lens, which provides a wide field of view that allows the modular camera 136 to capture a panoramic image of the surrounding area. In some embodiments, the modular camera 136 may use a wide-angle lens that provides a larger field of view than standard lenses, making it suitable for capturing large areas while maintaining more detail and less distortion compared to a fish-eye lens. In some embodiments, the modular camera 136 may use a movable lens that allows for pan, tilt, and zoom functionalities that provide dynamic tracking of moving objects or the ability to focus on specific areas of interest. In some embodiments, the modular camera 136 may be mounted on ceilings, poles, or other elevated structures to provide optimal coverage and maximize the field of view while minimizing potential obstructions.

Further, embodiments may include a wireless transmitter 138, which enables the seamless transmission of visual data captured by the camera 136 to the base station 102. The wireless transmitter 138 may be designed to ensure high-quality data transmission, maintain data integrity, and provide flexibility in the camera's 136 placement without the constraints of physical cabling. In some embodiments, the wireless transmitter 138 may support Wi-Fi technology, such as 802.11ac, 802.11n, etc., to provide high-speed wireless data transfer. In some embodiments, the wireless transmitter 138 may support Bluetooth Low Energy (“BLE”), which may be used for low-bandwidth data transmission, such as transmitting status updates or control signals. In some embodiments, the wireless transmitter 138 may utilize data compression algorithms to optimize bandwidth usage and reduce transmission latency. In some embodiments, the wireless transmitter 138 may use encryption protocols, such as WPA3, AES, etc., to secure the data during transmission. In some embodiments, the wireless transmitter 138 may be designed to maintain a strong and stable connection with the base station 102 over various distances depending on the technology used and environmental factors such as physical obstructions and interference. In some embodiments, the wireless transmitter 138 may include mechanisms to synchronize data streams with the base station 102 to ensure that the visual data is accurately aligned with other sensor data, such as phased array antenna 104 data, for integrated processing. In some embodiments, the wireless transmitter 138 may be capable of streaming real-time video and image data to the base station 102. In some embodiments, the wireless transmitter may provide real-time data transmission for monitoring, security, AR environments, retail, advertising, etc.

Further, embodiments may include a memory 140, which may temporarily store image data, manage pre-processing operations, and facilitate the smooth transmission of data to the base station. In some embodiments, the memory 140 may be RAM or random access memory, which may be used for short-term data storage and processing tasks. In some embodiments, the memory 140 may be flash memory or non-volatile memory used to store firmware, settings, and potentially pre-processed image data. In some embodiments, the memory 140 may include cache memory, which may be a type of volatile memory used to store frequently accessed data and instructions, speeding up data retrieval and processing. In some embodiments, the memory 140 may buffer incoming data, such as images or video frames, to manage the flow between capture and transmission. In some embodiments, the memory 140 may temporarily store image pre-processing data in RAM, including operations such as noise reduction, distortion correction, and basic image enhancement, ensuring these processes do not interrupt real-time data capture.

Further, embodiments may include a processing module 142, which begins with activating the modular camera system 134. The processing module 142 then establishes a secure and stable connection with the base station 102 to enable data transmission. The processing module 142 captures high-resolution images or video streams, adjusting focus and exposure for optimal quality. The captured image data undergoes preprocessing, including noise reduction, distortion correction, and image enhancement, to prepare it for analysis. The processing module 142 may transmit the pre-processed data to the integration module 128 for further processing, including object detection and 3D location tagging. The processing module 142 may continuously capture, preprocess, and transmit data to ensure continuous monitoring and real-time updates.

Further, embodiments may include a cloud 144 or servers, which may serve as the central processing and storage hub, managing the vast amounts of data collected by the base station 102 equipped with phased array antennas 104. The cloud 144 infrastructure may consist of high-performance servers that provide robust computational capabilities for processing and analyzing the data transmitted from the base station 102. In some embodiments, the servers may be designed to handle the algorithms used for signal processing, including angle of arrival operations, Kalman filtering, and JPDA operations. The cloud 144 performs extensive analysis to extract meaningful insights from the data received from the base station 102., which may include processing the extracted data to determine the location of target devices, filtering out outliers, and refining the tracking data to ensure accuracy. In some embodiments, the cloud 144 may leverage its high-speed computational power to run these algorithms efficiently, providing real-time feedback and updates to the base stations. In some embodiments, the cloud 144 may be responsible for storing the vast amounts of data generated by the system. In some embodiments, the cloud 144 may use various storage solutions to ensure that data is securely stored and easily retrievable for further analysis or historical reference.

Further, embodiments may include an application module 146, which utilizes the comprehensive data collected from the base station 102 and modular camera system 134. The application module 146 executes the real-time interaction module, security module, and ad module. The real-time interaction module may use positional and visual data to enhance user experiences in AR environments, including providing context-aware information, virtual guides, and interactive elements that respond to users'locations and movements. The security module may leverage facial recognition and movement prediction technologies to enhance security within the monitored area by continuously analyzing visual and positional data to identify individuals, monitor movements, and predict potential security breaches, providing real-time alerts and comprehensive monitoring. The ad module may focus on targeted advertising by using detailed user profiling and contextual analysis to deliver personalized advertisements. The ad module may select and personalize ad content based on user behavior, preferences, and location, optimizing ad effectiveness and engagement.

Further, embodiments may include a real-time interaction module 148, which enhances interactive experiences within AR applications. The real-time interaction module 148 may use data from the sync module 132 to dynamically respond to user inputs and changes in the environment, ensuring fluid and contextually relevant interactions. The real-time interaction module 148 may analyze the precise location, movements, and gestures of users and objects within the monitored environment. Then, the real-time interaction module 148 generates and renders virtual elements such as objects, informational overlays, and interactive buttons that are accurately aligned with the physical world from the user's perspective. The real-time interaction module 148 continuously monitors user gestures, employing algorithms and machine learning models to recognize and interpret actions like pointing or selecting virtual objects. The real-time interaction module 148 may trigger appropriate responses, such as displaying additional information or initiating interactions. The real-time interaction module 148 may adjust virtual elements in real-time to maintain a coherent and immersive experience, providing visual, auditory, or haptic feedback to enhance user engagement.

Further, embodiments may include a security module 150, which may ensure safety by using facial recognition, behavior analysis, and predictive modeling to monitor and identify potential threats in real time. The security module 150 may process data from cameras 136 and other sensors to verify identities, detect suspicious activities, and predict future movements. When threats are detected, the system alerts security personnel and can initiate protective measures like lockdowns or alarms, providing real-time monitoring and a comprehensive security overview.

Further, embodiments may include an ad module 152, which may deliver targeted advertisements and promotional content to users based on their location, behavior, and interactions within a monitored environment. The ad module 152 may use real-time positional data, visual recognition, and behavioral analysis to create detailed user profiles and segment them into categories. The ad module 152 may select and personalize ads from a predefined library, ensuring they are contextually relevant and delivered optimally, whether through digital screens, mobile notifications, or AR interfaces. The ad module 152 may track user interactions with ads to evaluate campaign effectiveness and continuously refine its algorithms for better personalization and engagement.

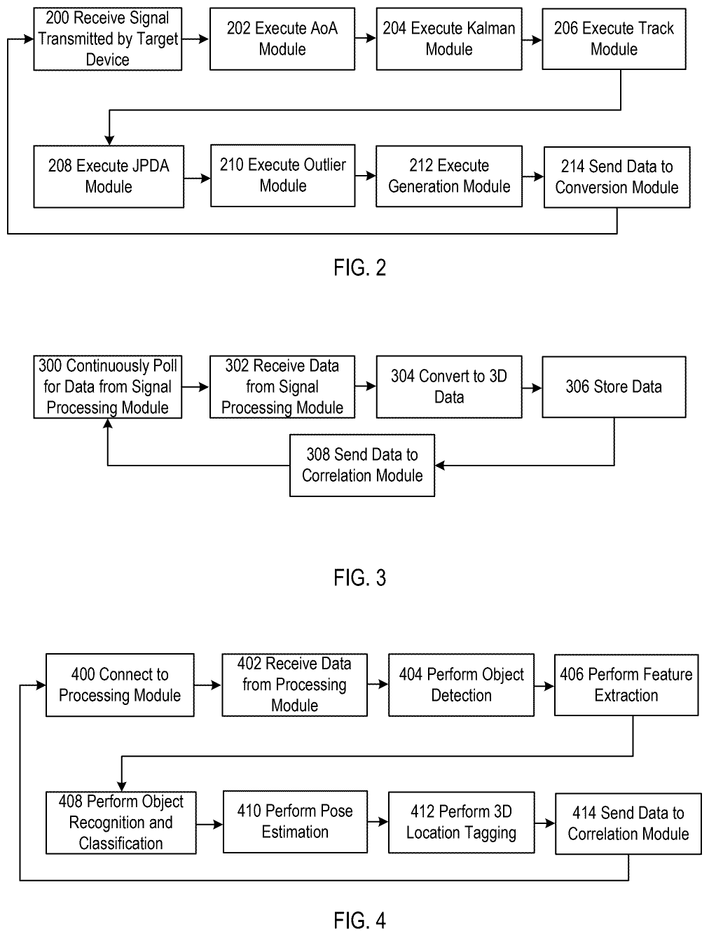

FIG. 2 illustrates a method performed by the signal processing module 124. The process begins with the signal processing module 124 receiving, at step 200, the signal transmitted by the target device. The signal processing module 124 executes, at step 202, the AoA module. The AoA module determines the precise direction from which a wireless signal originates. The AoA module may capture wireless signals through the phased array antenna 104. These elements may dynamically adjust their phase and amplitude to accurately determine the direction of incoming signals. When the phased array antenna 104 array receives a signal, each element captures the signal at slightly different times due to the spatial separation of the elements. The AoA module processes these time differences to calculate the angle of arrival of the signal. For example, the phased array antenna 104 captures incoming wireless signals from various directions. The AoA module measures the time differences between when the signal reaches each element. The AoA module calculates the phase differences of the received signal at each element. By analyzing these phase differences, the AoA module may determine the relative phase shifts caused by the different paths the signal takes to reach each element. Using the time distance of arrival and phase difference data, the AoA module may apply algorithms to calculate the precise angle from which the signal originated, which may involve solving geometric equations based on the known positions of the antenna elements and the measured time and phase differences. The elements may dynamically adjust their phase and amplitude to focus on the direction of the incoming signal. The beamforming capability enhances the accuracy of the angle of arrival determination by increasing the signal-to-noise ratio for the specific direction. The AoA module may perform real-time resistance monitoring of the elements to ensure optimal performance. The final angle of arrival data, indicating the precise direction of the incoming signal, is generated and outputted for further processing or immediate use in device tracking applications.

The signal processing module 124 executes, at step 204, the Kalman module. The Kalman module may accurately predict the position of wireless devices by filtering and smoothing the incoming signal data. The Kalman module may perform estimation techniques, such as the Kalman Filter, to provide real-time tracking and prediction of device movements, ensuring high accuracy and reliability. For example, the phased array antenna 104 may capture incoming wireless signals. In some embodiments, the initial processing may involve converting these captured signals into a format suitable for further analysis. The Kalman module may initialize the state vector, which represents the device's position and velocity. This state vector is based on the initial measurements obtained from the phased array antenna 104, providing a starting point for the estimation process. The Kalman Filter within the Kalman module may predict the future state of the device using a mathematical model. The model considers the previous state and incorporates assumptions about the device's movement, such as constant velocity or acceleration. The prediction may involve calculating the predicted state vector and the associated uncertainty, for example, a covariance matrix. As new signal measurements are received by the phased array antenna 104, the Kalman module updates the predicted state, which may involve comparing the predicted state with the actual measurements and computing the difference, known as the innovation or residual. The Kalman Filter then adjusts the state vector and the covariance matrix based on this innovation. The Kalman Gain is calculated to determine the optimal weight given to the new measurements versus the predicted state. The Kalman Gain ensures that the filter adapts appropriately to new information, balancing the influence of the prediction and the measurement. Using the Kalman Gain, the Kalman module may correct the state vector, refining the estimate of the device's position and velocity. This reduces the uncertainty in the state estimate, providing a more accurate and reliable prediction. The covariance matrix, representing the uncertainty of the state estimate, is updated to reflect the new measurements and the correction applied to ensure that the filter maintains an accurate assessment of the estimation uncertainty over time. The refined state vector, which represents a highly accurate estimate of the device's position and velocity, is generated as the output and may be used for real-time tracking, navigation, and other applications requiring precise location information.

The signal processing module 124 executes, at step 206, the track module. The track module may match incoming signals to their respective tracked devices to ensure that the system maintains accurate and continuous tracking of multiple devices in a dynamic environment. For example, the phased array antenna 104 may capture high-quality signals from multiple devices within its range. In some embodiments, the captured signals may undergo initial preprocessing to extract relevant features such as signal strength, time of arrival, and angle of arrival. For each incoming signal, the track module may generate a list of potential matches or candidates from the existing set of tracked devices, which may involve comparing the extracted signal features with the expected features of the tracked devices based on their predicted positions and characteristics. The track module calculates the likelihood that each candidate device is the source of the incoming signal. The calculation takes into account factors such as the proximity of the predicted position to the signal's point of origin and the similarity of the signal characteristics. In some embodiments, the track module may use various algorithms, such as the JPDA algorithm, to optimize the assignment of signals to devices. The JPDA algorithm may evaluate all possible assignments and select the one that maximizes the overall likelihood to ensure that the signals are matched to their correct sources. In some embodiments, multiple devices may have similar likelihoods for a given signal; the track module may employ additional criteria to resolve ambiguities, which may include historical movement patterns, signal strength trends, and other contextual information. The track module may output the final assignments of signals to devices, providing a clear and accurate mapping of incoming signals to their respective sources. In some embodiments, the mapping may be used to update the state estimates of the tracked devices. The track module may be responsible for maintaining and updating the tracks of devices over time. The track module ensures that the tracking system can handle the initiation, maintenance, and termination of device tracks, providing continuous and accurate tracking of multiple devices. In some embodiments, the track module uses the captured signal to initiate a new track, assigning a unique identifier and recording the initial position and velocity of the device. For each tracked device, the track module updates its state based on new signal measurements received by the phased array antenna 104. It may involve incorporating the latest position, velocity, and other relevant features into the existing track. The track module may predict the future position and state of each tracked device using mathematical models, which assist in maintaining continuous tracking even when signals are temporarily lost or obstructed. The track module confirms the existence of a track by continuously receiving and associating signals from the device over a specified period. In some embodiments, tracks that do not receive consistent signal updates are flagged for potential termination. The track module terminates tracks for devices that have left the monitoring range or have not been detected for an extended period, which may involve removing the track from the active list and recording the last known state of the device. The track module may maintain the integrity of each track by handling track splits and merges. For example, if a device's signal splits into multiple tracks or if multiple tracks converge into one, the track module may resolve these situations to ensure accurate tracking. In some embodiments, the track module may store historical data for each track, including the device's movement patterns, signal characteristics, and state estimates.

The signal processing module 124 executes, at step 208, the JPDA module. The JPDA module may improve the accuracy and reliability of data association in a dense signal environment. The phased array antenna 104 captures high-quality wireless signals from multiple devices. In some embodiments, the JPDA module may receive the preprocessed signals, which include various features, such as angle of arrival, time of arrival, and signal strength, and use these features to generate a preliminary association of signals to their respective tracked devices. The JPDA module performs the JPDA algorithm to handle situations where multiple signals may correspond to multiple devices. JPDA calculates the probabilities of different possible associations, considering the uncertainties and variances in signal measurements. For each potential association, the JPDA module calculates a likelihood score based on the consistency of the signal characteristics with the expected values for each tracked device, which may include factors such as predicted positions and signal properties derived from the phased array antenna 104. The JPDA module may optimize the overall data association by selecting the set of associations that maximize the joint probability. In some embodiments, the clean aspect of the JPDA module may involve filtering out unlikely associations and ensuring that each signal is assigned to the most probable device without overlaps or conflicts. In some embodiments, the JPDA module identifies and removes outliers that do not fit any probable track. In some embodiments, the outliers could be due to noise, spurious signals, or devices temporarily leaving the monitoring range. In some embodiments, the high sensitivity and accuracy of the graphene phased array antenna 104 help in distinguishing true signals from outliers. The JPDA module outputs the optimized association of signals to devices. In some embodiments, the association is used to update the state estimates and positions of the tracked devices to ensure accurate and continuous tracking. The JPDA module may continuously monitor its performance, adjusting the parameters of the JPDA algorithm based on real-time feedback to ensure that the JPDA module remains adaptive and robust in varying signal environments.

The signal processing module 124 executes, at step 210, the outlier module. The outlier module may handle measurements that arrive out of their expected order. The outlier module may ensure that the tracking system maintains high accuracy and reliability, even when data packets are delayed or received in an unexpected sequence. Each received signal is timestamped with the exact time of arrival, and the outlier module temporarily stores the received signals in a buffer. The outlier module sorts the signals based on their timestamps to determine the correct sequence of events. The outlier module may analyze the sequence of the buffered signals to identify any out-of-sequence measurements. It may compare the timestamps and expected order of the signals to detect discrepancies. In some embodiments, if an out-of-sequence measurement is identified, the outlier module adjusts the state estimates of the tracked devices. In some embodiments, the outlier module recalculates the positions and velocities of the devices based on the corrected sequence of signals. The outlier module may utilize a Kalman filter to update the state estimates with the out-of-sequence data. The outlier module may correct any errors introduced by the out-of-sequence measurements by recalibrating the tracking system to ensure that the device positions and velocities are consistent with the corrected data sequence. In some embodiments, the corrected and updated state estimates are integrated into the overall tracking system. The outlier module may ensure that the tracking system maintains a continuous and accurate representation of the device positions and movements.

The signal processing module 124 executes, at step 212, the generation module. The generation module transforms raw sensor data into a usable format for further processing and analysis. The generation module ensures that the data collected, such as the signals from the phased array antenna 104, is accurately converted and prepared for integration into the tracking system. In some embodiments, the phased array antenna 104 captures signals from multiple devices, and the generation module may receive the raw sensor data, including various parameters such as signal strength, frequency, phase information, and other relevant metrics. In some embodiments, the raw data may undergo initial preprocessing to remove any noise or irrelevant information. The preprocessed data is then converted into a standardized format that can be easily processed by the tracking system which may involve translating the raw sensor readings into digital values, ensuring compatibility with the system's data processing protocols. The generation module may standardize the units of measurement for the converted data to ensure consistency across different datasets and simplify the integration of data. The generation module may apply calibration adjustments to the converted data based on the characteristics of the phased array antenna 104 to ensure that the data reflects accurate measurements, accounting for any variations introduced by the system's hardware. In some embodiments, each data point is timestamped to ensure accurate tracking of the temporal sequence of events. The converted and standardized data is then packaged into a format suitable for transmission and further processing, which may involve organizing the data into structured packets that the tracking system can easily interpret. The generation module may prepare the packaged data for transmission to the central processing unit of the tracking system. In some embodiments, the converted, standardized, and quality-assured data may be transmitted to a central processing unit of the tracking system. The signal processing module 124 sends, at step 214, the data to the conversion module 126.

FIG. 3 illustrates a method performed by the conversion module 126. The process begins with the conversion module 126 continuously polling, at step 300, for the data from the signal processing module 124. In some embodiments, the conversion module 126 may regularly check for new data packets that have been processed by the signal processing module 124. The conversion module 126 receives, at step 302, the data from the signal processing module 124. The conversion module 126 receives the data from the signal processing module 124, including processed signals that have undergone an AoA analysis, and other filtering techniques.

The conversion module 126 converts, at step 304, the data to 3D data. The conversion module 126 receives the data that includes information about the AoA and ToA of signals captured by the phased array antenna 104 system. In some embodiments, the data may also include other parameters, such as signal strength and phase information. The conversion module 126 may employ a combination of geometric and trigonometric principles to convert the 2D signal data into 3D coordinates. The AoA data provides information about the direction from which the signal originated. In contrast, the ToA data gives insight into the distance between the signal source and the receiver, and this information is used to calculate the precise spatial location. The conversion may involve triangulation, a process that uses multiple measurements from different angles to pinpoint an exact location. By using the phase differences observed by different elements in the phased array antenna 104, the system may estimate the signal's source position in three-dimensional space, which may involve solving equations that describe the relationship between the observed angles, distances, and the positions of the antennas. The raw measurements may be in a coordinate system based on the sensor array's physical layout. The conversion module 126 may transform these coordinates into a standard 3D Cartesian coordinate system to integrate and analyze the data with other systems. In some embodiments, the transformation accounts for the positions and orientations of the sensors to ensure that the resulting 3D coordinates accurately represent the actual physical space. In some embodiments, calibration data may be used to correct any systematic errors in the measurements during the conversion process, which may include compensating for known biases in the sensor array, adjusting for environmental factors that might affect signal propagation, such as temperature or humidity, and refining the calculations based on real-time system diagnostics. The conversion module 126 may estimate the potential error or uncertainty in the calculated 3D coordinates, including assessing the quality of the input data and the confidence level in the resulting coordinates, allowing the system to provide an estimate of the accuracy. The 3D coordinates, with their associated error estimates, may then be formatted into a standardized data structure. The output may be stored in the system's memory 122 for further processing. It may be available to other modules, such as the correlation module 130, for integration with additional datasets, such as visual data from cameras.

The conversion module 126 stores, at step 306, the data. Once the data is converted into 3D coordinates, The conversion module 126 stores the 3D coordinates in a structured format. In some embodiments, the stored data may be accessed by other modules or systems as needed. The conversion module 126 sends, at step 308, the data to the correlation module 130, and the process returns to continuously polling to receive the data from the signal processing module 124.

FIG. 4 illustrates a method performed by the integration module 128. The process begins with the integration module 128 connecting, at step 400, to the processing module 142. The integration module 128 establishes a connection with the processing module 142, which may be facilitated through a secure and reliable data link, which may involve wired or wireless communication channels. The integration module 128 receives, at step 402, the data from the processing module 142. The integration module 128 receives the data from the processing module 142 and includes the pre-processed images captured by the modular camera system 134, containing visual information for further analysis. In some embodiments, the data transfer may be optimized to handle high-resolution images and video streams to ensure that the quality and integrity of the data are preserved during transmission.

The integration module 128 performs, at step 404, object detection. The integration module 128 initiates the object detection process, which may involve analyzing the incoming image data to identify and locate objects within the scene. The integration module 128 may employ machine learning algorithms, such as convolutional neural networks or CNNs, trained to recognize a wide range of objects, including active tags, mobile devices, and other relevant entities. The detected objects may be marked with bounding boxes, with their positions recorded for further processing.

The integration module 128 performs, at step 406, feature extraction. The integration module 128 may extract features from the identified objects, which may involve identifying unique characteristics, such as edges, textures, shapes, and colors, that are used to differentiate one object from another. In some embodiments, the features may be used to create descriptors, such as unique identifiers that represent each object.

The integration module 128 performs, at step 408, object recognition and classification. The integration module 128 performs object recognition and classification by comparing the extracted features with a pre-existing database of known objects, matching them to identify the type and identity of each detected object. In some embodiments, the integration module 128 may use classification algorithms to assign objects to specific categories, such as “mobile phone,” “active tag,” or “person.”The integration module 128 performs, at step 410, pose estimation. The integration module 128 determines the orientation and position of each detected object relative to the camera 136 and the environment, which may involve calculating the object's spatial coordinates and rotation angles using methods such as Perspective-n-Point (“PnP”) algorithms and triangulation. In some embodiments, pose estimation may provide a detailed understanding of how each object is situated in 3D space.

The integration module 128 performs, at step 412, 3D location tagging. The integration module 128 may tag the objects with precise 3D location coordinates. The integration module 128 may convert the 2D image coordinates into 3D spatial data and align it with the environment's coordinate system. In some embodiments, the tagging ensures that objects detected and recognized by the system are accurately mapped in the real world, enabling high-precision applications such as navigation, object tracking, and AR experiences.

The integration module 128 sends, at step 414, the data to the correlation module 130, and the process returns to receiving the data from the processing module 142. The integration module 128 transmits the processed data, including the object detections, features, classifications, poses, and 3D location tags, to the correlation module 130. The process then returns to the integration module 128 receiving new data from the processing module 142 to ensure continuous and real-time analysis.

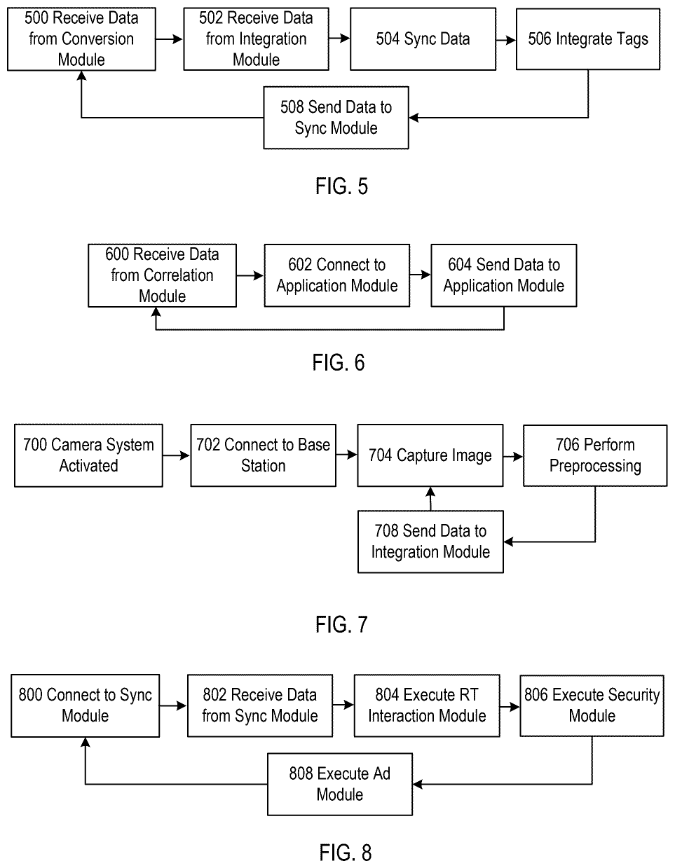

FIG. 5 illustrates a method performed by the correlation module 130. The process begins with the correlation module 130 receiving, at step 500, the data from the conversion module 126. The data may include the 3D coordinates of objects and entities derived from the signal data processed by the signal processing module 124. The conversion module 126 converts these signals, originally captured by the phased array antenna 104, into spatial data that provides a precise 3D positioning framework. The correlation module 130 receives, at step 502, the data from the integration module 128. The dataset may consist of detailed visual information, including detected objects, their features, classifications, and pose estimations, all derived from image data captured by the modular camera system 134. The visual data may include 3D coordinates generated from the camera system's 134 perspectives, ensuring alignment with the 3D spatial framework.

The correlation module 130 syncs, at step 504, the image data and the antenna data. The synchronization may involve matching the timing and spatial coordinates of the objects and entities captured by both systems. The correlation module 130 may align these datasets to ensure that each object's visual representation is accurately matched with its corresponding 3D spatial data, accounting for any time lags or discrepancies between the two data sources. For example, the first step in synchronization may involve aligning the timestamps of the two data sets. The correlation module 130 compares the timestamps from both sources to ensure they are within a permissible range of each other. In some embodiments, if there are discrepancies due to delays in data processing or transmission, the correlation module 130 may adjust the timing to align the datasets as closely as possible. The temporal alignment ensures that the spatial data from the phased array antenna 104 and the visual data from the cameras 136 represent the same time frame for accurate tracking and analysis. The correlation module 130 performs spatial synchronization, which involves mapping the 2D coordinates from the image data to the 3D spatial coordinates provided by the antenna data. The mapping process may use camera 136 calibration data, which includes information about the camera's 136 position, orientation, and intrinsic properties like focal length and lens distortion. By applying these parameters, the correlation module 130 may accurately project 2D image coordinates into the 3D space, aligning the visual representation of objects with their actual positions in the physical environment as determined by the phased array antenna 104. The correlation module 130 may verify the alignment's accuracy by cross-referencing known reference points or markers in the environment. In some embodiments, the correlation module 130 may check for consistency in object positions and may adjust the synchronization parameters if discrepancies are found. The output dataset provides a comprehensive view of the environment, combining the positional information from the antenna with the visual details from the camera. In some embodiments, the augmented reality may be processed on the base station 102, including the computational tasks used for rendering AR content, such as real-time processing of visual data, object recognition, and the accurate tracking of mobile devices and objects in the environment. In some embodiments, the phased array antenna 104 may allow for precise tracking of devices through techniques such as AoA, providing centimeter-level accuracy in determining the location and orientation of each device. In some embodiments, the GPU in the base station may process graphical computations needed to create realistic and immersive digital objects and overlays. In some embodiments, the GPU's parallel processing capabilities enable it to handle multiple rendering tasks simultaneously, ensuring smooth and responsive AR experiences even when multiple devices are involved. In some embodiments, the base station 102 may enable a shared augmented reality experience, where multiple devices, such as smartphones, AR glasses, or other user devices, may view the same digital object from different perspectives. In some embodiments, viewing the same digital object from different perspectives may be achieved by maintaining accurate real-time data on the position and orientation of each device relative to the digital object and the physical environment. For example, a first device may see the front of a digital sculpture, a second device the back of the digital sculpture, and a third device the right side of the digital sculpture, creating a consistent and coherent AR experience, where all users perceive the digital objects as being anchored in a fixed location in the real world. In some embodiments, the base station 102 may continuously update the position and orientation data for all participating devices, adjusting the AR content, accordingly, including real-time adjustments for changes in user viewpoint, ensuring that the digital objects appear stationary and consistent regardless of the user's movement or the angle from which they are viewed. In some embodiments, the base station 102 may allow for interactions with the digital objects, such as rotating them, changing their size, or adding annotations, with these changes being immediately reflected across all devices. In some embodiments, the base station 102 may be integrated with a modular camera system 134 and equipped with a phased array antenna 104. For example, single-camera systems 134 may be limited in determining the exact distance of objects from the camera 136. While a camera 136 may identify that an object, such as a person, is within its field of view, it cannot accurately measure how far that object is without employing additional cameras 136 and stereoscopic techniques. For example, stereoscopy may use multiple cameras placed at different angles, along with significant processing power, to estimate depth and distance, making it an expensive and complex solution. The phased array antenna 104 integrated with the camera 136 provides an efficient and accurate method for determining the precise position of objects, including human faces, in three-dimensional space, such as XYZ coordinates. The phased array antenna 104 may be capable of detecting and tracking the position of devices emitting wireless signals, such as mobile phones, hearing aids, pacemakers, smartwatches, and even vehicles. By combining the data from the phased array antenna 104 with visual data from the camera 136, the base station 102 may correlate the detected wireless signals with the individuals captured in the camera's 136 view allowing for the accurate identification and tracking of people along with their associated devices. In some embodiments, the integration enables the base station 102 to achieve centimeter-level accuracy in tracking the positions of detected faces and devices in real-time. The phased array antenna 104 provides the capability to determine the angle and distance of the devices from the base station 102, while the camera 136 adds visual identification and context. The fusion of the data sources creates a comprehensive tracking system that can not only identify individuals but also associate them with their electronic devices. In some embodiments, if the phased array sensor is not physically connected to the camera 136, the data from both may be fused together to enable the same high level of tracking accuracy and functionality. In some embodiments, the phased array antenna 104 and camera 136 may be placed in different locations as needed, while maintaining the ability to correlate device signals with visual data. In some embodiments, the fusion of device signals with visual data may be valuable in environments where it is useful to identify and track individuals and their devices accurately, such as in security systems, smart buildings, and retail spaces. For example, in a security application, the base station 102 may identify and track unauthorized individuals along with their associated devices, providing a detailed overview of both the people and technology present in the area which enhances situational awareness and may be used to trigger alerts or take other automated actions based on the detected data.

The correlation module 130 integrates, at step 506, the tags. The correlation module 130 integrates tags from both the image and antenna data. The integration process may involve merging the meta-information from both datasets, such as visual identifiers from the camera 136 data and signal-based identifiers from the antenna data. In some embodiments, the tagging process may provide a unified and comprehensive view of each tracked object or entity, combining visual attributes with spatial positioning and other relevant metadata.

The correlation module 130 sends, at step 508, the data to the sync module 132, and the process returns to receiving the data from the conversion module 126. The dataset may include fully synchronized visual and spatial data, complete with integrated tags and precise 3D location information. In some embodiments, the sync module 132 may further process the data for real-time applications, cloud storage, or other system functions, ensuring that the entire system can utilize accurate and up-to-date information for various tasks.

FIG. 6 illustrates a method performed by the sync module 132. The process begins with the sync module 132 receiving, at step 600, the data from the correlation module 130. The sync module 132 receives the processed and synchronized data from the correlation module 130, including a combination of 3D positional information and visual data that has been accurately synchronized. In some embodiments, the data may include detailed information such as the precise locations of objects or individuals, their movement trajectories, and any associated meta-tags that aid in identification or categorization. The sync module continuously listens for incoming data packets to ensure that the flow of information from the correlation module is uninterrupted and up to date. The sync module 132 connects, at step 602, to the application module 146. The sync module 132 establishes a connection with the application module 146, which may involve setting up a communication channel that may handle the transmission of data. In some embodiments, the connection may be established over a wired network, such as Ethernet or wireless, depending on the system's architecture and requirements. In some embodiments, the sync module 132 may ensure that the connection is secure, reliable, and capable of handling the data volume and speed for real-time applications.

The sync module 132 sends, at step 604, the data to the application module 146, and the process returns to receiving the data from the correlation module 130. In some embodiments, the data transmission may be conducted in a manner that ensures minimal latency and maximum accuracy, useful for applications that rely on real-time data, such as AR systems or security monitoring. The sync module 132 may manage the data packets to ensure they are sent in the correct order and without loss. In some embodiments, the sync module 132 may also implement error-checking mechanisms to detect and correct any data corruption that might occur during transmission. In some embodiments, the data sent may include all relevant information needed for the application module 146 to function effectively, such as object positions, movement patterns, and any relevant meta tags or classifications. The sync module 132 returns to the initial state of receiving data from the correlation module 130, ensuring a continuous and cyclic process, where the sync module 132 constantly updates the application module 146 with the latest synchronized data.

FIG. 7 illustrates a method performed by the processing module 142. The process begins with the camera system being activated, at step 700. The modular camera system 134 is initialized, which may involve powering up the hardware components and initializing the software systems. In some embodiments, the modular camera system 134 may check internal systems and ensure that the memory 140 and data buffers are cleared and ready to store new data. In some embodiments, the modular camera system 134 may establish a baseline calibration for the modular camera 136 to ensure the image captures are accurate and consistent. The processing module 142 connects, at step 702, to the base station 102. In some embodiments, the processing module 142 may establish a wireless or wired connection with the base station 102 to transmit data captured by the modular camera 136. In some embodiments, the connection may involve establishing a secure and stable communication link, such as through Wi-Fi, Bluetooth, or other networking standards supported by the modular camera system 134 and base station 102. In some embodiments, the processing module 142 may negotiate data transfer protocols and speeds, ensuring that the data can be transmitted efficiently and reliably.

The processing module 142 captures, at step 704, the image. In some embodiments, the modular camera's 136 sensors may include high-resolution digital sensors capable of capturing detailed images in various lighting conditions. In some embodiments, the processing module 142 may utilize the modular camera's 136 optics and sensors to adjust focus, exposure, and other parameters to capture the image. In some embodiments, the modular camera 136 may capture images continuously or may be triggered by specific events or intervals, depending on the system's requirements.

The processing module 142 performs, at step 706, the preprocessing of the captured image data. The pre-processing may include enhancing the quality of the captured image and preparing it for more analysis. The processing module 142 may perform noise reduction, where various filtering techniques are applied to minimize the noise inherent in the raw image data. In some embodiments, the noise may arise from sensor imperfections or environmental factors. The processing module 142 may apply distortion correction, such as in embodiments where the modular camera 136 contains wide-angle or fisheye lenses. In some embodiments, the correction may adjust the image to compensate for lens-induced distortions to ensure that straight lines in the scene remain straight in the image. In some embodiments, contrast adjustment and sharpening may be applied to improve image clarity. The processing module 142 sends, at step 708, the data to the integration module 128, and the process returns to capturing the image. The processing module 142 may transfer the data through the established communication link. In some embodiments, the integration module 128 may be responsible for further processing the image data, including tasks like object detection, feature extraction, and 3D location tagging. In some embodiments, the processing module 142 may perform the additional processing of the image data and send the output of the processing to the integration module 128.

FIG. 8 illustrates a method performed by the application module 146. The process begins with the application module 146 connecting, at step 800, to the sync module 132. The application module 146 establishes a secure and reliable connection to the sync module 132 to ensure that data transmission between the two modules is continuous and uninterrupted. The application module 146 receives, at step 802, the data from the sync module 132. The application module 146 may receive the synchronized data from the sync module 132, including comprehensive 3D positional information, visual data, and correlated tags, all processed and refined by previous system modules. In some embodiments, the data enables the application module 146 to perform various functions depending on the specific requirements of the applications running in the cloud 144.

The application module 146 executes, at step 804, the real-time interaction module 148. The real-time interaction module 148 leverages the data received from the sync module 132 to facilitate and enhance interactive experiences, primarily within augmented reality (“AR”) applications. The real-time interaction module 148 may be designed to respond dynamically to user inputs and environmental changes, ensuring that the interactions are fluid, precise, and contextually relevant. For example, the real-time interaction module 148 may begin by analyzing the received information. The real-time interaction module 148 may interpret the precise location and movements of users and objects within the monitored environment. The data includes the coordinates of users, their gestures, and the positions of various objects or markers within the AR space. The real-time interaction module 148 may use the data to understand the user's current state and context, forming the basis for subsequent interactions. The real-time interaction module 148 may generate and render virtual elements that are overlaid onto the user's view. In some embodiments, the elements may include virtual objects, informational overlays, interactive buttons, or other visual aids that enhance the user's experience. The rendering process may ensure that these virtual elements are accurately aligned with the physical environment, taking into account the user's perspective and movements. For example, in an AR tour guide application, the real-time interaction module 148 may display information about exhibits as the user approaches them, with the content appearing at the correct spatial location relative to the exhibit. The real-time interaction module 148 may continuously monitor the user's gestures and interactions, using camera 136 data and other sensors to detect movements such as pointing, waving, or selecting virtual objects. The real-time interaction module 148 may employ algorithms and machine learning models to accurately recognize and interpret these gestures. For example, if a user points at a virtual object, the system may identify this action and trigger a corresponding response, such as displaying additional information or initiating an interaction. The real-time interaction module 148 may dynamically adjust the virtual elements to maintain a coherent and immersive experience, including repositioning or scaling virtual objects based on the user's viewpoint and distance, updating content in response to new inputs, and ensuring that interactions are seamless. In some embodiments, the real-time interaction module 148 may provide immediate feedback on the user's actions, enhancing the sense of interaction and engagement. In some embodiments, the feedback may be visual, auditory, or haptic, depending on the capabilities of the AR system. For example, if the user selects a virtual button, the real-time interaction module 148 may display a visual confirmation, play a sound, or provide a tactile response. For example, in a warehouse setting, the combined camera 136 and phased array antenna 104 data may create a highly detailed and interactive digital representation of the physical space, enabling individuals who are not physically present in the warehouse to explore it remotely using devices like smartphones, computers, or AR/VR headsets. In some embodiments, the system may function similarly to a first-person video game, where the user can navigate through the warehouse in a first-person perspective. In some embodiments, the camera 136 may capture visual data, while the phased array antenna 104 tracks the precise location of various assets and individuals within the warehouse. The data may then be synchronized and rendered into a virtual environment that mirrors the real-world layout and conditions. Users may see assets such as pallets, machinery, or inventory items, all accurately placed according to their real-world positions. In some embodiments, the system may include tagging capabilities, where items are marked with digital labels or tags. In some embodiments, remote users may interact with these tags, accessing detailed information about each asset, such as contents, current location, or handling instructions. In some embodiments, the users may update the tags, for example, to relabel items or mark them for relocation. If an item needs to be moved, the remote user may send a notification to someone physically present in the warehouse, who may then handle the task. In some embodiments, this function provides a means to streamline inventory management, quality control, and other logistical operations, reducing the need for physical presence and allowing for more efficient use of resources. In some embodiments, this function may be applied to enhance experiences at concerts, festivals, or other large gatherings. By integrating cameras 136 and phased array antennas 104 throughout the event venue, a detailed digital replica of the event environment may be created. In some embodiments, remote attendees may then “enter” the event virtually using AR/VR headsets or other devices, experiencing the event as if they were physically present. For example, in the virtual space, users may see and interact with other attendees, both virtual and physical, in real-time. For example, they could virtually stand next to friends who are physically at the event, viewing the event from the same perspective and engaging in shared experiences. In some embodiments, the system's tracking capabilities ensure that the positions and movements of both physical and virtual attendees are accurately represented, enhancing the sense of presence and immersion. In some embodiments, the system may facilitate social interactions through features like sending friend requests or AR social connection requests. Users may interact digitally, engaging in conversations or activities as if they were actually at the event. For example, they could virtually explore different areas of the venue, enjoy the performances, or interact with digital content and promotions set up specifically for remote attendees, including exclusive virtual merchandise, special camera angles, or interactive AR elements that enhance the event experience. In some embodiments, the visual data from the camera 136 and the tracking data provided by the base station 102 may utilize AI/ML technologies to enhance retail shopping experiences. In some embodiments, the system may utilize AI/ML algorithms to monitor consumer behavior in the store, recognizing faces and identifying devices like smartphones and smartwatches that shoppers carry. The system may track specific actions, such as a consumer picking up and then putting back an item, by using computer vision techniques and asset tag data for precise product identification. In some embodiments, the system may record non-negative consumer behaviors, providing valuable insights into shopper preferences and patterns. For example, repeated interactions with a particular product without a purchase can trigger targeted promotions or information to encourage a sale. In some embodiments, the system may provide support for autonomous shopping and cashier less checkout. For example, consumers may use a mobile app to interact with products, such as by pointing their phone at an item; they may view detailed information or make a purchase through a “1-click checkout” process. The system may confirm purchases visually and audibly, enhancing the user experience with clear signals like a green aura or a confirmation sound. In some embodiments, the app interface may allow users to select items on their screen, providing further options such as viewing additional details or confirming the purchase. The system's asset tags, which offer real-time information on product locations and status, support the seamless integration of digital and physical shopping environments, ensuring precise tracking and facilitating efficient inventory management. In some embodiments, the system may utilize these AI/ML algorithms for additional applications, including healthcare, industrial, event management, smart cities, immersive training and simulation environments, entertainment venues, transportation, hospitality, and residential applications such as smart homes, agriculture, etc. In some embodiments, the base station 102 may serves as the foundational infrastructure for real-time, real-space social media applications, by integrating the camera 136 visual data and the tracking data from the base station 102. In some embodiments, the system may enable gesture-based interactions using smartphones or augmented reality interfaces. For example, by pointing their phone in someone's direction, users may initiate a gesture that allows them to view a profile above that person's head, leveraging tracking and camera integration, allows users to tap on individuals'digital representations to access their profiles. In some embodiments, once a profile is accessed, a menu of additional options may become available, providing various interactive features. In some embodiments, users may send friend requests, transfer money, or view more detailed profiles, all seamlessly integrated into the AR experience. In some embodiments, the system may enhance social interactions and create new opportunities for digital engagement in physical spaces. In some embodiments, the system may be used for networking at events, enhancing shopping experiences, or facilitating real-time social interactions, and the camera 136 and tracking system may provide a platform for a wide range of applications. In some embodiments, the system may be used in a plurality of applications, including but not limited to personalized customer experiences, contactless payments, cashier-less checkouts, real-time social interactions and networking, enhanced security and safety monitoring, augmented reality-based education and training, interactive features for live events and entertainment, remote collaboration and telepresence, etc.

The application module 146 executes, at step 806, the security module 150. The security module 150 may utilize the data received from the sync module 132 to ensure the safety and security of the environment and its occupants. The security module 150 may monitor, identify, and respond to potential security threats in real-time, using various technologies, such as facial recognition, probabilistic movement prediction, and behavior analysis. For example, the security module 150 may begin by acquiring data from the sync module 132, which includes 3D positional data, visual data from the modular camera system 134, and metadata such as timestamps. The security module 150 preprocesses the data to ensure it is in a usable format, correcting any discrepancies or errors and filtering out irrelevant information. The security module 150 scans the visual data for faces using facial recognition algorithms. The security module 150 extracts facial features and compares them against a pre-existing database of authorized and unauthorized individuals. The comparison allows the system to identify persons within the monitored area, verifying their identities against known records. In some embodiments, the facial recognition system may work under various lighting conditions and angles by using feature extraction techniques and machine learning models. The security module 150 may analyze the behavior of individuals within the environment. The security module 150 may monitor movements, interactions, and patterns of behavior, looking for signs of suspicious or unusual activities. The analysis may include tracking the speed, direction, and mannerisms of individuals using algorithms that detect deviations from typical behavior patterns. For example, loitering near sensitive areas, erratic movements, or unauthorized access attempts can trigger alerts. The security module 150 may employ probabilistic models to predict the potential future movements of identified individuals based on their past behavior and current trajectory. The predictive capability allows the system to anticipate potential security threats, such as unauthorized entry into restricted zones or theft. In some embodiments, the security module 150 may use data from the phased array antenna 104 and modular camera system 134 to enhance the accuracy of these predictions. In some embodiments, the security module 150 may generate alerts if a potential threat is detected or an unauthorized individual is identified. In some embodiments, the alerts may be configured to trigger various responses, such as notifying security personnel, locking down specific areas, or activating other security measures like alarms or cameras. In some embodiments, the security module 150 may provide real-time monitoring capabilities, displaying live feeds and data visualizations to security operators. In some embodiments, the security module 150 may offer a comprehensive overview of the current security status, including the locations and identities of individuals, ongoing alerts, and predicted threat scenarios.

The application module 146 executes, at step 808, the ad module 152, and the process returns to receiving the data from the sync module 132. The ad module 152 may be responsible for delivering targeted advertisements and promotional content to users based on their location, behavior, and interactions within the monitored environment. The ad module 152 may leverage the data collected and processed by the system, including real-time positional data, visual recognition, and behavioral analysis, to provide personalized and contextually relevant advertisements. The ad module 152 may acquire data from the sync module 132, which includes the 3D coordinates of users, their movement patterns, and visual data from the modular camera system 134. The data may be used to establish the context of each user, such as their location within a retail space, their proximity to specific products or displays, and their interactions with these products. The ad module 152 may utilize additional metadata, such as the time of day, day of the week, and current events, to enhance the relevance of the advertisements. Based on the collected data, the ad module 152 creates detailed profiles for each user. In some embodiments, the profiles may include demographic information, past behaviors, purchase history, and preferences. In some embodiments, the users are segmented into various categories based on these profiles, such as frequent shoppers, first-time visitors, or individuals with specific interests. The segmentation may allow the system to tailor the content to each user's unique characteristics and preferences. The ad module 152 may select advertisements from a pre-defined library based on the user profiles and contextual data. The ad module 152 may use algorithms to match the most relevant ad content with the appropriate user segment. For example, a user interested in sports may receive ads related to sporting goods or upcoming sports events. The ad module 152 may personalize the ads further by incorporating real-time data, such as current promotions or discounts available at nearby stores. The ad module 152 may determine the optimal delivery mechanism, including displaying the ad on digital screens within the environment, sending a notification to the user's mobile device, or overlaying the content in an AR interface if the user is using AR glasses or a similar device. In some embodiments, the delivery may be timed and placed to maximize visibility and impact to ensure that the user receives the ad at the right moment. The ad module 152 may track the user's interactions with the ad, such as clicks, views, or physical engagement with the advertised products. In some embodiments, the ad module 152 may include a feedback mechanism that collects data on user interactions and responses to the ads. The data may be analyzed to assess the performance of each ad campaign, including metrics like click-through rates, conversion rates, and user engagement levels. The ad module 152 may use the feedback to continuously optimize the selection and personalization algorithms to improve the relevance and effectiveness of future ads.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

What is claimed is:

1. A system comprising:
a phased array antenna;
a signal processing module configured to detect wireless signals received from one or more target devices;
a conversion module configured to determine 3D spatial data for the one or more target devices based on the wireless signals;
an integration module configured to:
receive visual data from at least one camera;
perform object detection and classification on the visual data to detect and classify one or more objects; and
tag the one or more objects with 3D coordinates based on the 3D spatial data for the one or more target devices; and
a correlation module configured to synchronize the 3D spatial data from the conversion module with the visual data from the integration module including object detection and classification information for use in a cloud-based augmented reality (AR) content to augment social networking and targeted advertising.

2. The system of claim 1, further comprising a modular camera system including the at least one camera, wherein the modular camera system further includes a wireless transmitter configured to transmit the visual data from the at least one camera to the integration module.

3. The system of claim 1, wherein the signal processing module operates in an active mode by initially pinging the one or more target devices via the phased array antenna before detecting the wireless signals from the one or more target devices; or wherein the signal processing module operates in a passive mode by detecting the wireless signals without first pinging the one or more target devices.

4. The system of claim 1, wherein the conversion module determines the 3D spatial data for the one or more target devices by triangulation and/or trilateration.

5. The system of claim 1, wherein the conversion module determine the 3D spatial data the one or more target devices using at least one of an Angle of Arrival (AoA) measurement, a Time of Arrival (ToA) measurement, a Kalman filter, a Joint Probabilistic Data Association (JPDA) operation, and/or a Multiple Signal Classification (MUSIC) algorithm.

6. The system of claim 1, wherein the integration module is further configured to perform object recognition on the one or more objects using machine learning.

7. The system of claim 1, wherein the integration module is further configured to perform pose estimation to determine an orientation and position of the one or more objects in 3D space.

8. The system of claim 7, wherein the integration module performs the pose estimation using one or more of Perspective-n-Point (“PnP”) algorithms and triangulation.

9. The system of claim 1, wherein the integration module is further configured to:
perform feature extraction on the one or more objects to extract one or more features;
generate a descriptor for the one or more objects based on the one or more features; and
associate the descriptor with the one or more objects as a tag.

10. The system of claim 1, wherein the integration module is configured to use object classification to assign the one or more objects to a particular category.

11. A method comprising:
detecting, by a phased array antenna, wireless signals received from one or more target devices;
determining 3D spatial data for the one or more target devices based on the wireless signals;
receiving visual data from at least one camera;
performing object detection and classification on the visual data to detect and classify one or more objects;
tagging the one or more objects with 3D coordinates based on the 3D spatial data for the one or more target devices; and
synchronizing the 3D spatial data with the visual data and object detection and classification information for use in a cloud-based augmented reality (AR) content to augment social networking and targeted advertising.

12. The method of claim 11, wherein the at least one camera is part of a modular camera system including a wireless transmitter.

13. The method of claim 11, wherein detecting is performed in an active mode by initially pinging the one or more target devices via the phased array antenna before detecting the wireless signals from the one or more target devices; or wherein detecting is performed in a passive mode by detecting the wireless signals without first pinging the one or more target devices.

14. The method of claim 11, wherein determining the 3D spatial data for the one or more target devices includes using one or more of triangulation and/or trilateration.

15. The method of claim 11, wherein determining the 3D spatial data for the one or more target devices includes using one or more of an Angle of Arrival (AoA) measurement, a Time of Arrival (ToA) measurement, a Kalman filter, a Joint Probabilistic Data Association (JPDA) operation, and/or a Multiple Signal Classification (MUSIC) algorithm.

16. The method of claim 11, further including performing object recognition on the one or more objects using machine learning.

17. The method of claim 11, further including performing pose estimation to determine an orientation and position of the one or more objects in 3D space.

18. The method of claim 17, wherein performing the pose estimation includes using one or more of Perspective-n-Point (“PnP”) algorithms and triangulation.

19. The method of claim 11, further including:
performing feature extraction on the one or more objects to extract one or more features;
generating a descriptor for the one or more objects based on the one or more features; and
associating the descriptor with the one or more objects as a tag.

20. The method of claim 11, further including performing object classification to assign the one or more objects to a particular category.
